(19) United States
(12) Patent Application Publication
(10) Pub. No.: US 2019/0220801 A1
(43) Pub. Date: Jul. 18, 2019

(54) PREDICTING THE PROBABILITY OF OPPORTUNITIES TO BE WON FROM ORGANIZATION INFORMATION

(71) Applicant: INTERNATIONAL BUSINESS MACHINESS CORPORATION, ARMONK, NY (US)

(72) Inventors: Aly Megahed, San Jose, CA (US); Hamid R. Motahari Nezhad, San Jose, CA (US); Taiga Nakamura, Sunnyvale, CA (US); Samir Tata, Cupertino, CA (US); Peifeng Yin, San Jose, CA (US)

(21) Appl. No.: 15/873,360

(22) Filed: Jan. 17, 2018

(51) Int. Cl. G06Q 10/06; G06Q 10/10

(52) U.S. Cl. CPC G06Q 10/063118; G06Q 10/1053; G06Q 10/063112

(57) ABSTRACT

One embodiment provides for predicting and planning of staffing needs for services including obtaining data from an opportunity pipeline. The data including current and historical project information, offerings information included in each opportunity and current and historical staffing information. An optimization model is generated to provide a threshold for deals predicted to be won. A threshold of win score for deals to be considered as predicted to be won is optimized. Opportunities to be won are predicted including: executing a win prediction model for current opportunities in the opportunity pipeline, filtering deals with scores less than the win score threshold, processing a deal progress monitoring model for each remaining deal to predict a future event and related timeline, and simulating progress of each deal by updating each deal with a predicted event until an end of a simulation time window.

### BACKGROUND

Services organizations need to plan for required staffing and infrastructure resources ahead of contract signatures, and are notified of upcoming staffing needs when contracts are signed (or almost close to be signed). Hiring takes time, which is dependent on the skill set. There is a limit on the budget, and it is typically not possible to hire in-advance without proper justification. Conventional hiring methods focus on overall seasonal changes and are timeline based. Conventional hiring methods end up with the results of either not hiring all the needed resources on-time or hiring more resources than needed. Current hiring methods use demand as an input.

### SUMMARY

Some embodiments relate to predicting and planning of staffing needs for services (e.g., information technology (IT) services). One embodiment provides a method for predicting and planning of staffing needs for services including obtaining data from an opportunity pipeline. The data including current and historical project information, offerings information included in each opportunity and current and historical staffing information. An optimization model is generated to provide a threshold for deals predicted to be won. A threshold of win score for deals to be considered as predicted to be won is optimized. Opportunities to be won are predicted including: executing a win prediction model for current opportunities in the opportunity pipeline, filtering deals with scores less than the win score threshold, processing a deal progress monitoring model for each remaining deal to predict a future event and related timeline, and simulating progress of each deal by updating each deal with a predicted event until an end of a simulation time window.

One or more embodiments relate to matching skills for offerings for IT services. One embodiment provides for matching skills for offerings including obtaining data comprising historical opportunity information and offering information. A processor determines an associated skill set for each offering based on the data. An amount of each skill associated with each unit of each offering is determined. Skills for each offering under consideration are forecasted based on the amount of each skill associated with each unit of each offering and the offering information.

Other embodiments relate to solution-aware staffing hiring based on project information (e.g., for information technology (IT) services). One embodiment provides a method for solution-aware staffing hiring based on project information including obtaining constraint information. Data is obtained that includes current and historical project information, offerings information included in each opportunity, and current and historical staffing information. A processor predicts opportunities and offerings to be won based on the data. Offerings are mapped to skills required for the offerings. The processor determines the skills required for the offerings predicted to be won. The processor determines staffing hiring based on the opportunities predicted to be won, the constraint information and the determined skills required.

These and other features, aspects and advantages of the present invention will become understood with reference to the following description, appended claims and accompanying figures.

### BRIEF DESCRIPTION OF THE DRAWINGS

FIG. 1 depicts a cloud computing environment, according to an embodiment;

FIG. 2 depicts a set of abstraction model layers, according to an embodiment;

FIG. 3 is a network architecture for efficient representation, access and modification of variable length data objects, according to an embodiment;

FIG. 4 shows a representative hardware environment that may be associated with the servers and/or clients of FIG. 1, according to an embodiment;

FIG. 5 is a block diagram illustrating system for predicting and planning of staffing needs for services, according to one embodiment;

FIG. 6 illustrates block diagram for a system flow for resource prediction and staffing for information technology (IT) services delivery, according to one embodiment;

FIG. 7 illustrates a block diagram of a system flow for predicting the probability of opportunities to be won from organization information, according to one embodiment;

FIG. 8 illustrates a block diagram for a process for predicting the probability of opportunities to be won from organization information, according to one embodiment;

FIG. 9 illustrates a block diagram for a process for matching skills for offerings, according to one embodiment; and

FIG. 10 illustrates a block diagram for a process for solution-aware staffing hiring based on project information, according to one embodiment.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

One or more embodiments provide for predicting and planning of staffing needs for services (e.g., IT services). One embodiment provides a method for predicting and planning of staffing needs for services delivery including obtaining data from an opportunity pipeline. The data including current and historical project information, offerings information included in each opportunity and current and historical staffing information. An optimization model is generated to provide a threshold for deals predicted to be won. A threshold of win score for deals to be considered as predicted to be won is optimized. Opportunities to be won are predicted including: executing a win prediction model for current opportunities in the opportunity pipeline, filtering deals with scores less than the win score threshold, processing a deal progress monitoring model for each remaining deal to predict a future event and related timeline, and simulating progress of each deal by updating each deal with a predicted event until an end of a simulation time window.

Another embodiment provides for matching skills for offerings including obtaining data comprising historical opportunity information and offering information. A processor determines an associated skill set for each offering based on the data. An amount of each skill associated with each unit of each offering is determined. Skills for each offering under consideration are forecasted based on the amount of each skill associated with each unit of each offering and the offering information.

Still another embodiment provides a method for solution-aware staffing hiring based on project information including obtaining constraint information. Data is obtained that includes opportunity information and offerings information included in each opportunity. A processor predicts opportunities and offerings to be won based on the data. Offerings are mapped to skills required for the offerings. The processor determines the skills required for the offerings predicted to be won. The processor determines staffing hiring based on the opportunities predicted to be won, the constraint information and the determined skills required.

One or more embodiments provide for automating the whole delivery staffing process, making it more accurate, more efficient, and less resource-intensive (resources needed to do the planning itself). The one or more embodiments reduce penalties of late deliveries caused by the absence of needed staff to perform the delivery, and reduce unnecessary staff hiring including the costs incurred with such unnecessary hiring.

In this specification, the terms “win”, “won”, or “winning” are used to generally refer to a successful outcome in relation to a service deal (e.g., a service provider bidding on the deal wins the deal). The terms “lose”, “lost”, or “losing” are used to generally refer to an unsuccessful outcome in relation to a service deal (e.g., a service provider bidding on the deal loses the deal because a competing service provider won the deal, the service provider stopped bidding on the deal, or a client decided not to pursue the deal). The term “deal outcome” is used to generally refer to whether a service deal is won (i.e., a successful outcome) or lost (i.e., an unsuccessful outcome).

Cloud computing is a model of service delivery for enabling convenient, on-demand network access to a shared pool of configurable computing resources (e.g., networks, network bandwidth, servers, processing, memory, storage, applications, virtual machines (VMs), and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed and automatically, without requiring human interaction with the service's provider.

Broad network access: capabilities are available over a network and accessed through standard mechanisms that promote use by heterogeneous, thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned and, in some cases, automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported, thereby providing transparency for both the provider and consumer of the utilized service.

Service Models are as follows:

Software as a Service (SaaS): the capability provided to the consumer is the ability to use the provider's applications running on a cloud infrastructure. The applications are accessible from various client devices through a thin client interface, such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is the ability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is the ability to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is a service oriented with a focus on statelessness, low coupling, modularity, and semantic interoperability. At the heart of cloud computing is an infrastructure comprising a network of interconnected nodes.

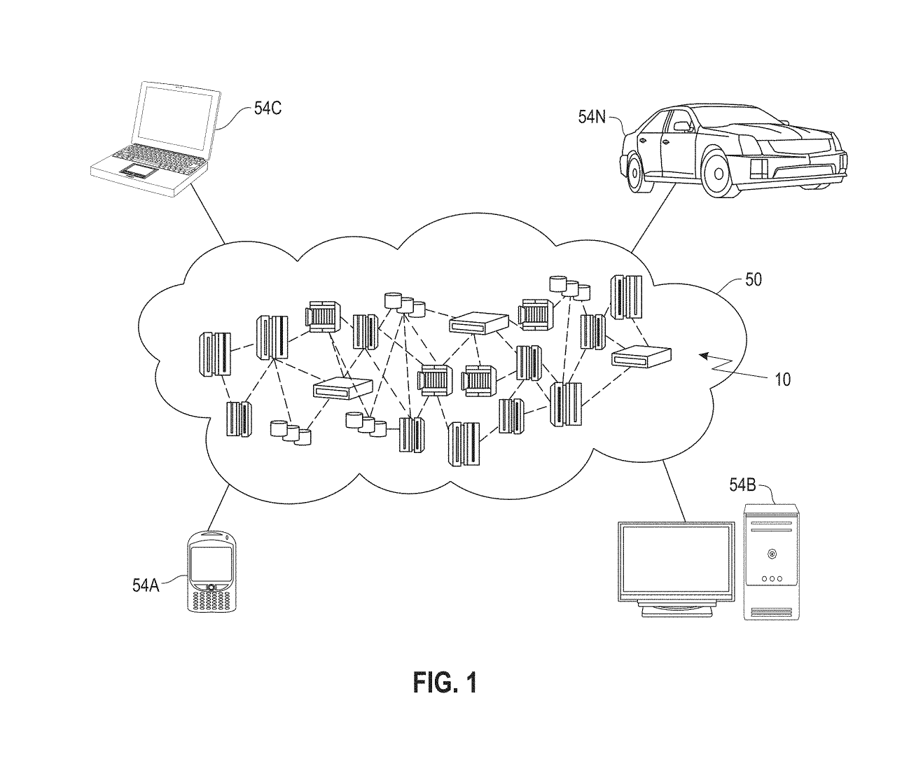

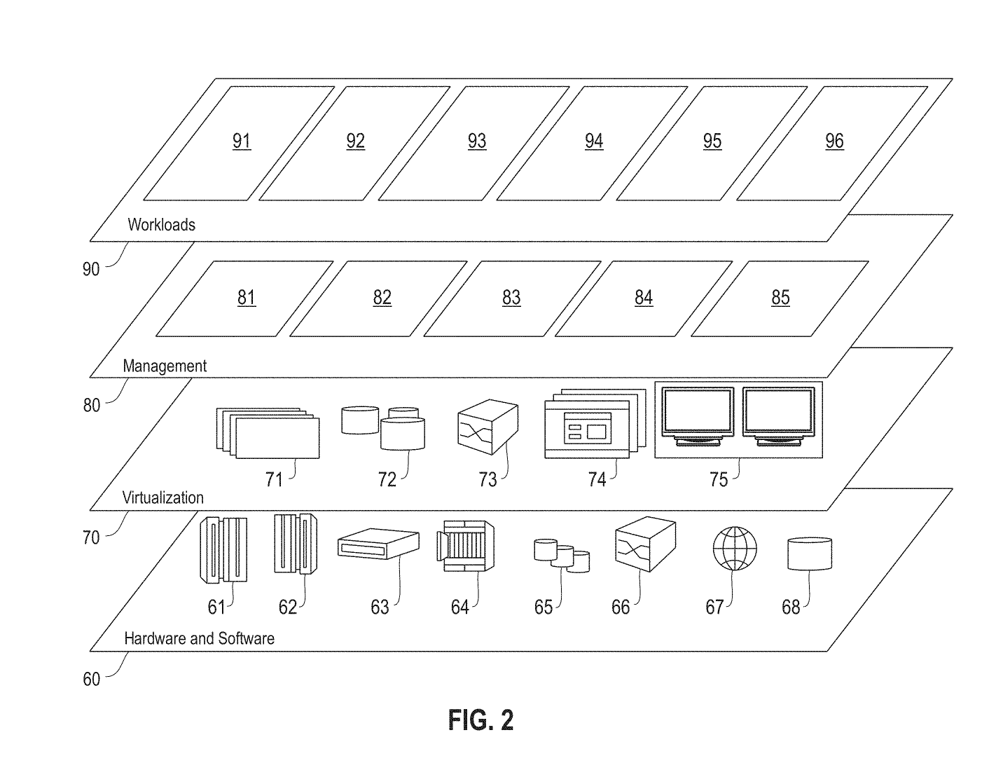

Referring now to FIG. 1, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows the cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

Referring now to FIG. 2, a set of functional abstraction layers provided by the cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, a management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment and billing or invoicing for consumption of these resources. In one example, these resources may comprise application software licenses. Security provides identity verification for cloud consumers and tasks as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and predicting the probability of opportunities to be won from organization information processing 96. As mentioned above, all of the foregoing examples described with respect to FIG. 2 are illustrative only, and the invention is not limited to these examples.

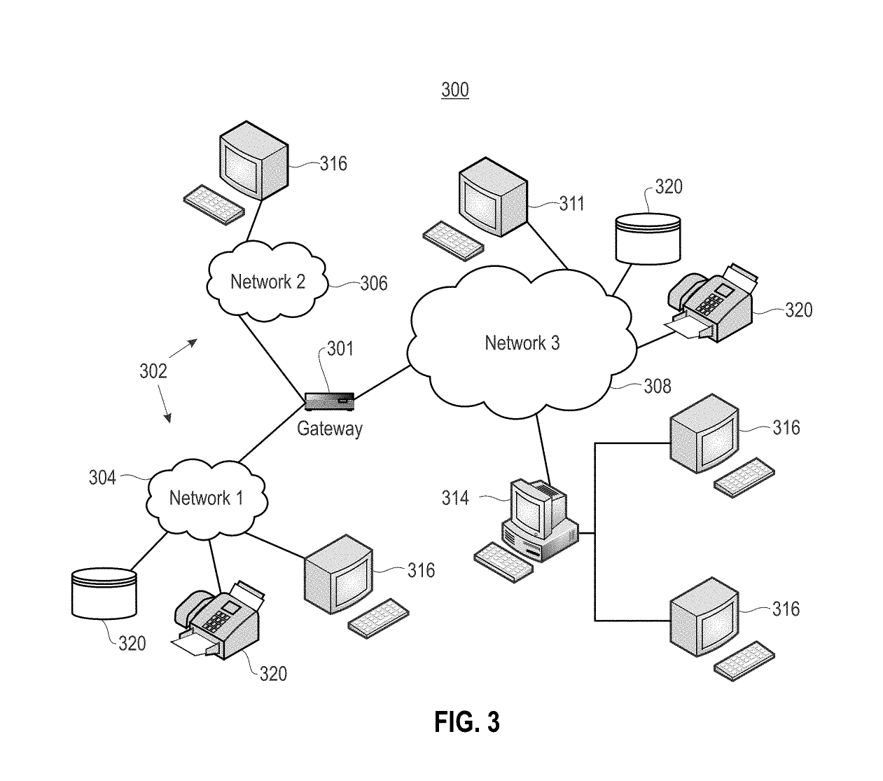

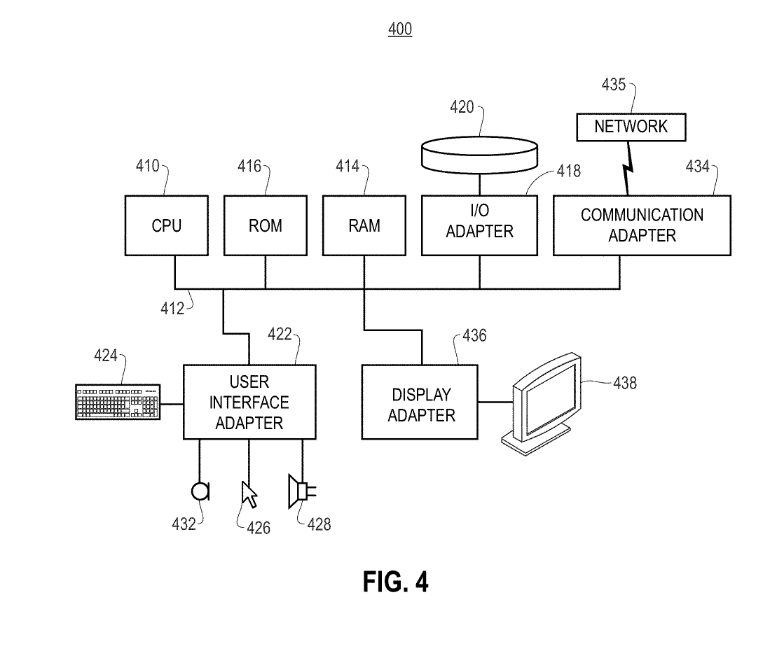

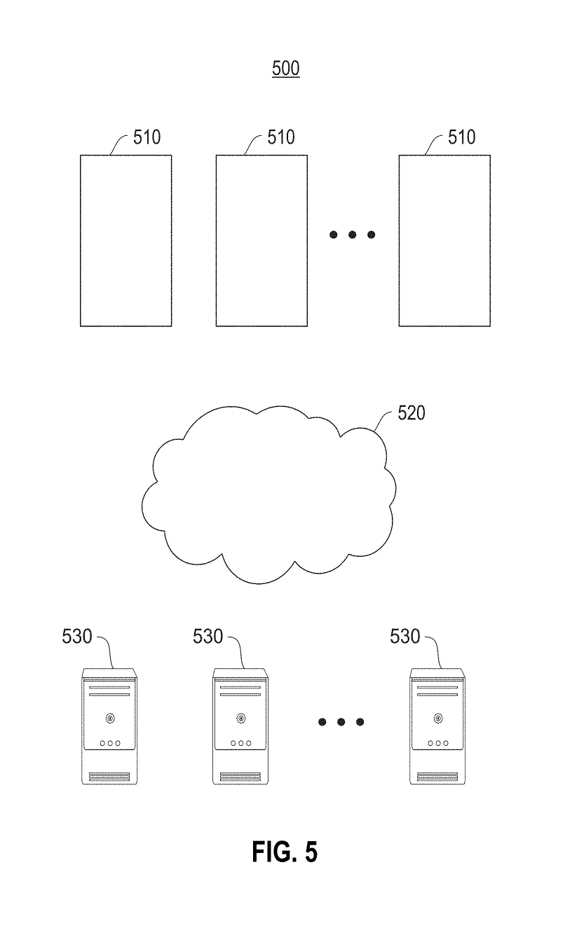

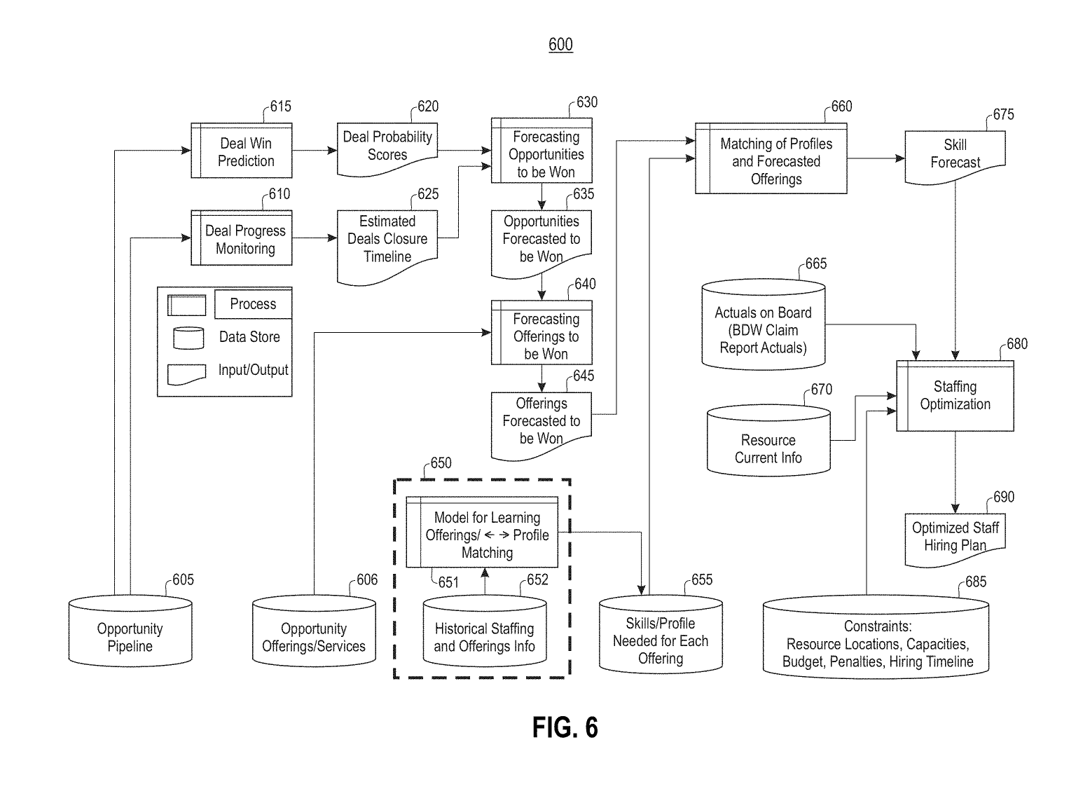

It is understood all functions of one or more embodiments as described herein may be typically performed by the cloud computing environment 500 (FIG. 1), the processing system 300 (FIG. 3), system 400 (FIG. 4), system 500 (FIG. 5) or system 600 (FIG. 6), which can be tangibly embodied as hardware processors and with modules of program code. However, this need not be the case for non-real-time processing. Rather, for non-real-time processing the functionality recited herein could be carried out/implemented and/or enabled by any of the layers 60, 70, 80 and 90 shown in FIG. 2.

It is reiterated that although this disclosure includes a detailed description on cloud computing, implementation of the teachings recited herein are not limited to a cloud computing environment. Rather, the embodiments of the present invention may be implemented with any type of clustered computing environment now known or later developed.

FIG. 3 illustrates a network architecture 300, in accordance with one embodiment. As shown in FIG. 3, a plurality of remote networks 302 are provided, including a first remote network 304 and a second remote network 306. A gateway 301 may be coupled between the remote networks 302 and a proximate network 308. In the context of the present network architecture 300, the networks 304, 306 may each take any form including, but not limited to, a LAN, a WAN, such as the Internet, public switched telephone network (PSTN), internal telephone network, etc.

In use, the gateway 301 serves as an entrance point from the remote networks 302 to the proximate network 308. As such, the gateway 301 may function as a router, which is capable of directing a given packet of data that arrives at the gateway 301, and a switch, which furnishes the actual path in and out of the gateway 301 for a given packet.

Further included is at least one data server 314 coupled to the proximate network 308, which is accessible from the remote networks 302 via the gateway 301. It should be noted that the data server(s) 314 may include any type of computing device/groupware. Coupled to each data server 314 is a plurality of user devices 316. Such user devices 316 may include a desktop computer, laptop computer, handheld computer, printer, and/or any other type of logic-containing device. It should be noted that a user device 311 may also be directly coupled to any of the networks in some embodiments.

A peripheral 320 or series of peripherals 320, e.g., facsimile machines, printers, scanners, hard disk drives, networked and/or local storage units or systems, etc., may be coupled to one or more of the networks 304, 306, 308. It should be noted that databases and/or additional components may be utilized with, or integrated into, any type of network element coupled to the networks 304, 306, 308. In the context of the present description, a network element may refer to any component of a network.

According to some approaches, methods and systems described herein may be implemented with and/or on virtual systems and/or systems, which emulate one or more other systems, such as a UNIX system that emulates an IBM z/OS environment, a UNIX system that virtually hosts a MICROSOFT WINDOWS environment, a MICROSOFT WINDOWS system that emulates an IBM z/OS environment, etc. This virtualization and/or emulation may be implemented through the use of VMWARE software in some embodiments.

FIG. 4 shows a representative hardware system 400 environment associated with a user device 316 and/or server 314 of FIG. 3, in accordance with one embodiment. In one example, a hardware configuration includes a workstation having a central processing unit 410, such as a microprocessor, and a number of other units interconnected via a system bus 412. The workstation shown in FIG. 4 may include a Random Access Memory (RAM) 414, Read Only Memory (ROM) 416, an I/O adapter 418 for connecting peripheral devices, such as disk storage units 420 to the bus 412, a user interface adapter 422 for connecting a keyboard 424, a mouse 426, a speaker 428, a microphone 432, and/or other user interface devices, such as a touch screen, a digital camera (not shown), etc., to the bus 412, communication adapter 434 for connecting the workstation to a communication network 435 (e.g., a data processing network) and a display adapter 436 for connecting the bus 412 to a display device 438.

In one example, the workstation may have resident thereon an operating system, such as the MICROSOFT WINDOWS Operating System (OS), a MAC OS, a UNIX OS, etc. In one embodiment, the system 400 employs a POSIX® based file system. It will be appreciated that other examples may also be implemented on platforms and operating systems other than those mentioned. Such other examples may include operating systems written using JAVA, XML, C, and/or C++ language, or other programming languages, along with an object oriented programming methodology. Object oriented programming (OOP), which has become increasingly used to develop complex applications, may also be used.

FIG. 5 is a block diagram illustrating a system 500 for predicting (or forecasting) the probability of opportunities to be won from organization information, according to one embodiment. In one embodiment, the system 500 includes client devices 510 (e.g., mobile devices, smart devices, computing systems, etc.), a cloud or resource sharing environment 520, and servers 530. In one embodiment, the client devices are provided with cloud services from the servers 530 through the cloud or resource sharing environment 520.

FIG. 6 illustrates a block diagram illustrating a system 600 for resource prediction and staffing for IT services delivery, according to one embodiment. In one embodiment, system 600 includes the following processes: deal progress monitoring 610, deal win prediction 615, forecasting (or predicting) opportunities to be won 630, forecasting (or predicting) offerings to be won 640, optional model for learning offerings/profile matching 650 including model for learning offerings↔profile matching 651, matching profiles and forecasted (or predicted) offerings 660 and staffing optimization 680. In one embodiment, system 600 includes the following data stores: opportunity pipeline 605, opportunity offerings/services 606, optional historical staffing and offerings information 652, skills/profile needed for each offering 655, actuals on board 665 (e.g., banking data warehouse (BDW) claim report actuals), current resource information 670 and constraints 685 (e.g., resource locations, capacities, budget, penalties, hiring timeline, etc.). In one embodiment, system 600 includes the following input/output: deal probability scores 620, estimated deals closure timeline 625, opportunities forecasted/predicted to be won 635, offerings forecasted/predicted to be won 645, skill forecast 675 and optimized staff hiring plan 690. The details of the components of system 600 are described further below.

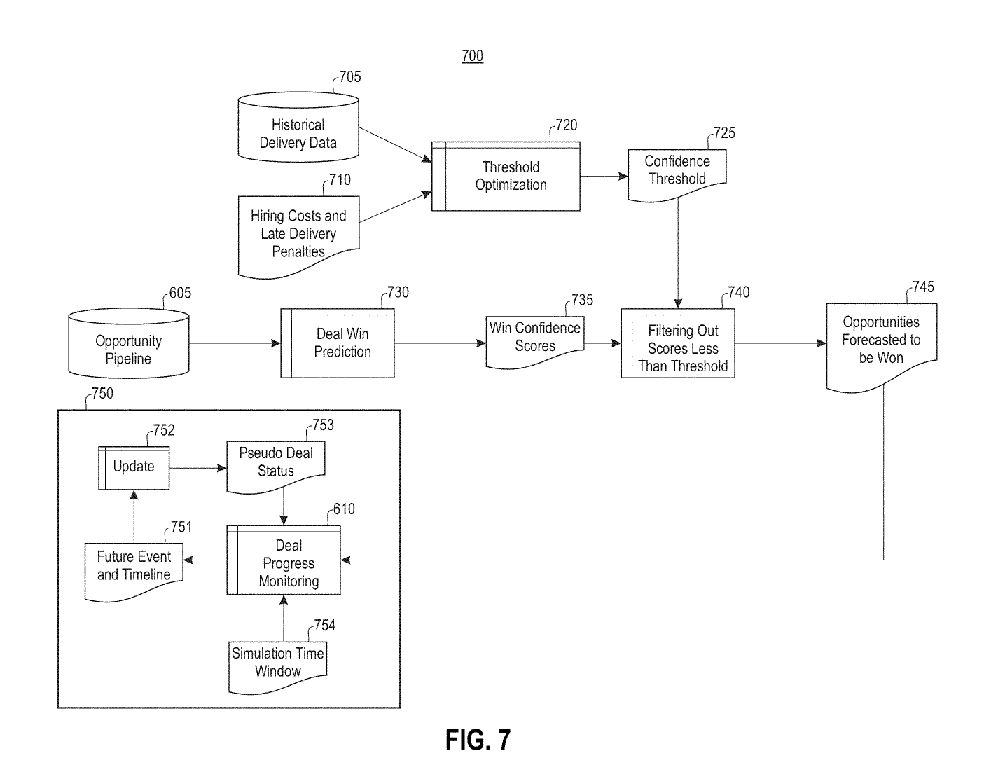

FIG. 7 illustrates a block diagram of a system flow 700 for predicting the probability of opportunities to be won from organization information, according to one embodiment. In one embodiment, the system flow 700 includes the following processes: threshold optimization 720, deal win prediction 730, filtering out scores less than the threshold 740, deal progress monitoring 610 and update 752. In one embodiment, system flow 700 includes the following data stores: historical delivery data 705 and opportunity pipeline 605. In one embodiment, system flow 700 includes the following input/output: hiring costs and late delivery penalties 710, confidence threshold 725, win confidence scores 735, opportunities forecasted (or predicted) to be won 745, future event and timeline 751, pseudo deal status 753, and simulation time window 754. In one embodiment, simulation processing 750 includes the following components: update process 752, deal progress monitoring 610 and input/outputs: future event and timeline 751, pseudo deal status 753 and simulation time window 754.

In one embodiment, the system flow 700 includes executing the deal win prediction processing 730 on the current opportunity pipeline 605 to predict which deals would be won. In one embodiment, deal win prediction processing 730 may include a training unit that is configured to apply, in a training stage, known supervised machine learning techniques to train a predictive analytics model (“prediction model”) for use in assessing probability of winning an in-flight deal for any price point at any price point based on historical data pricing, market data pricing, a user-specified price, and/or any other price point. The prediction model is trained based on metadata for deals. In one embodiment, the prediction model is a naïve Bayesian model. In one embodiment, the system flow 700 uses the score threshold (described below) to filter out opportunities with scores less than the threshold in the filtering out scores less than the threshold processing 740.

In one embodiment, for each opportunity that remains, the simulation processing 750 includes the following processing: use deal progress monitoring 610 to obtain the time interval and next event via maximum likelihood. If the simulation time window 754 is reached or the next event is a win/loss, go to next processing item; otherwise, update the deal status with the update processing 752 and return to deal progress monitoring 610. If the next event is a win, the simulation processing 750 adds to the set of opportunities forecasted to be won 745 in the current time period. Otherwise, the simulation processing 750 discards the information.

In one embodiment, the tradeoff to be optimized is performed by the system flow 700 as follows. If the score threshold is too high, then the system flow 700 will predict less opportunities to be won than what the actual output would be, which will result into predicting less required resources and will lead to being late in the deliveries (because the hired resources are not enough), which would result in having to pay late penalties to customers. On the other hand, if the score threshold is too low, then more opportunities will be predicted to be won than what the actual output would be, which will result in predicting more required resources than what is actually needed, and thus an organization will end up hiring more than needed and that would result in extra unnecessary hiring costs.

In one embodiment, using the historical delivery data 705, the system flow 700 calculates an objective function at any given score threshold by simulating all the rest of the processing described herein, putting into account the two above tradeoffs, and putting a constraint that the score threshold is between 0 and 1. Then, an optimization approach (e.g., Gaussian Optimization, Grid Search, . . . etc) may be used to look into the search space for the optimal score threshold value to be used on future data.

In the previous described processing, it is assumed that there is only one (1) threshold (1 bucket) and the system flow 700 compares the score out of the win prediction processing for each deal with that score threshold. In one embodiment, the following additional processing is added. For a received (e.g., user selected) number of buckets, for the nth bucket, the system flow 700 computes the probability of winning at least one of any n deals sharing the same offering using the score of these deals as their probability of winning (that score is the output of the deal win prediction processing 730 model). These n deals have not been considered as won (or pseudo-won) in any of the previous buckets. If that probability is greater than the score threshold of the 1st bucket, then system flow 700 creates a pseudo-won deal that has that offering only. The amount of that offering is equal to the weighted average of the amount of that offering in these deals (it is weighted by the score of that deal out of the deal win prediction processing 730 model). The probability of winning at least one deal in the deals used to construct any of the aforementioned pseudo-deals is determined as follows: the probability that at least one deal is won among these deals=1−Probability that all these deals are lost=1−Σ_{i∈these deal'slist} Probability that deal i is lost=1−Σ_{i∈these deal'slist} (1−Probability that deal i is won), where probability that a deal is won is taken as its score that is outputted from the deal win prediction processing 730 model. Note that here it is assumed independence of the chances of winning any deal.

Returning to FIG. 6, in one embodiment, predicting (or forecasting) offerings to be won processing 640 includes the following. Given the opportunities predicted (or forecasted) to be won (from results of the predicting (or forecasting) opportunities to be won processing 630), and matching between opportunities and offerings (in the opportunity offering/services data store 606), this processing straightforwardly includes determining the forecasting of offerings to be won. In one embodiment, the input includes a set of historical opportunities, which include: a set of offerings delivered, involved skillset (not necessarily associated to offerings directly), and user-defined thresholds for the minimum support and confidence (support and confidence described below). The output includes the association of offerings <=>{Skill1, Skill2, Skill3, . . . } as well as the number of units from each skill required for each unit of each offering.

In one embodiment, system 600 includes processing for determining the skill set associated with each offering. In one embodiment, the projects are read nto memory, and a processor builds the implication rule of size k of the skill set (initilizing k=1): offering−>{skill}. The system 600 proceeds to determine the rule support (frequency), which is how many times this offering appeared along with that skill across all opportunities, and confidence (conditional probability over all projects), that is the frequency divided by the sum of (frequency+number of times in which that offering appeared and the skill set did not appear across all opportunities). Note that system 600 used skill set here because starting from k=2, it becomes a skill set rather than a single skill. The rules are kept that have support and confidence scores above received user defined thresholds. System 600 increases k, the size of the consequent of the rules to 2, 3, . . . . The above processing is repeated until there is no consequent size N meeting thresholds. System 600 proceeds to find the minimum set of skill sets with a maximal skill set size in their consequent, covering all individual skill sets that meet the threshold requirements over the projects.

In one embodiment, system 600 determines the amount of each skill associated with each unit of each offering as follows. For each opportunity i, system 600 determines the skill units via summing up the number of people who worked on that opportunity and had that skill. Note that if a person had other skills along with that skill, system 600 considers that skill to be (1/(that number of skills that this person has)). For each opportunity, system 600 determines the contribution of each of its skills to the offerings in that opportunity that are assumed to require that skill as per the output of finding the minimum set of skill sets with a maximal skill set size in their consequent. In one embodiment, system 600 determines this contribution by dividing the number of skill units calculated above by the sum of the quantities of all offerings requiring this skill (as per the output of finding the minimum set of skill sets with a maximal skill set size in their consequent) in that opportunity. For each offering and skill (if that offering requires that skill as per the output of finding the minimum set of skill sets with a maximal skill set size in their consequent), determine the amount of that skill for each unit of that offering by calculating the average (or median or any function) of the contribution of that skill to that offering across all opportunities that had this offering and that skill.

In one embodiment, system 600 performs matching of profiles and predicted (or forecasted) offerings process 660 as follows. Given the skills/profiles needed for each offering data store 655 (e.g., a database) and the offerings forecasted to be won 645, this process determines the forecasted skills for all considered offerings.

In one embodiment, the staffing optimization process 680 determines how many persons are needed to hire and having which skill sets, when there is a need to hire these people, and assigns such persons to the different opportunities at the different geographical areas as well as provide times when they would work on these opportunities. In another embodiment, the staffing optimization process 680 chooses among all potential hires with given skill sets. The objective function of the staffing optimization process 680 is to minimize the costs of: staffing hiring at each time period, cost of assignment of staff members to the different opportunities in each location, and cost of late delivery due to lack of some staff/skill at particular times (since the staffing optimization process 680 may not be able to provide hiring of all needed resources at all times because of budget constraints and hiring constraints). In one embodiment, the constraints are: total number of available resources at any point of time+resources available due to hiring if they are hired+unmet demand >=needed resources at that point of time; budget constraints at any time period must not be exceeded (all costs incurred at the time period has to be less than the maximum budget); capacities of maximum allocated resources to opportunities and any other capacities have to not be exceeded; hiring timelines have to be fulfilled (i.e., for any hire that the staffing optimization process 680 determines to do, that hire would be available only after the given hiring timeline for such skill set); and constraints insuring that resource assignments that are not possible, do not happen (e.g., some resources might not be allowed to be assigned to a particular opportunity or another). In one example embodiment, the resulting staffing optimization process 680 includes a model that is a mixed integer linear programming model.

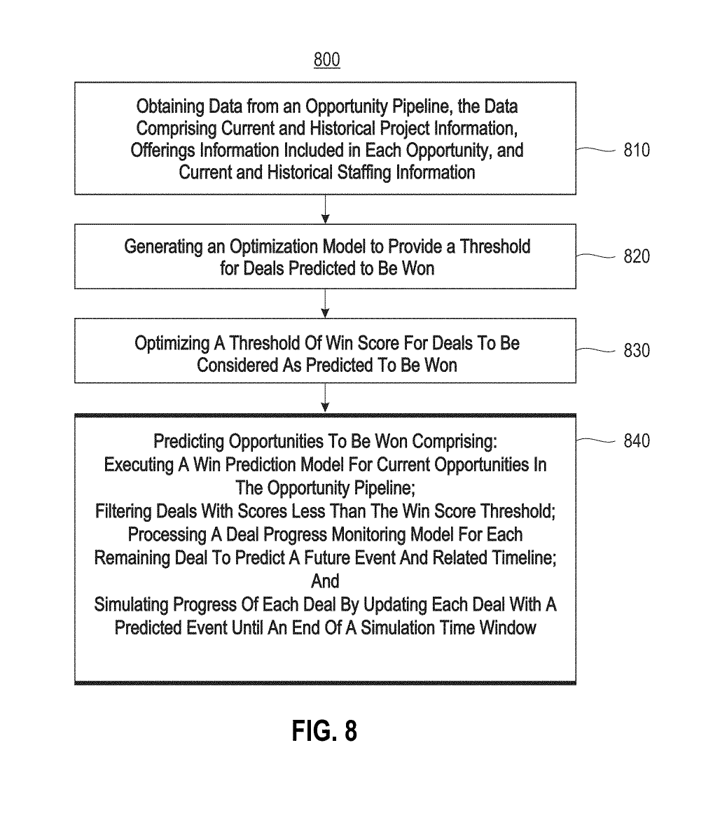

FIG. 8 illustrates a block diagram for a process 800 for forecasting the probability of opportunities to be won from organization information, according to one embodiment. In block 810, process 800 obtains data from an opportunity pipeline. In one embodiment, the data includes current and historical project information, offerings information included in each opportunity and current and historical staffing information. In block 820, process 800 generates (e.g., using a processor in cloud computing environment 50, FIG. 1, system 300, FIG. 3, system 400, FIG. 4, system 500, FIG. 5, or system 600, FIG. 6), an optimization model to provide a threshold for deals predicted to be won. In block 830, process 800 optimizes a threshold of win score for deals to be considered as predicted to be won. In block 840, process 800 predicts opportunities to be won, which includes: executing a win prediction model for current opportunities in the opportunity pipeline, filtering deals with scores less than the win score threshold, processing a deal progress monitoring model for each remaining deal to predict a future event and related timeline, and simulating progress of each deal by updating each deal with a predicted event until an end of a simulation time window.

In one embodiment, for process 800, the opportunity pipeline may include: resource locations, workload capacity information, budget information, penalty information, hiring timeline information, late delivery information, hiring cost information, assignment cost of staff to opportunity information, etc. In one embodiment, deals that end up with a predicted event as won are deals predicted to be won. In on embodiment, the optimization model optimizes tradeoff between penalties paid to customers for late deliveries and any unnecessary hiring and staffing costs.

In one embodiment, process 800 may further include receiving a selected number of data buckets to be used, and constructing, for any data bucket, pseudo-won deals from a number of deals equal to a particular number of that data bucket and that did not make it through any lower numbered data buckets. In one embodiment, the pseudo-won deals are constructed as having a probability of winning equal to a probability that at least one of the deals used in constructing it will be won based on a score output from the win prediction processing model.

In one embodiment, for process 800 the probability that at least one of the deals in a list for each bucket is determined based on assuming independence between chances of winning each deal.

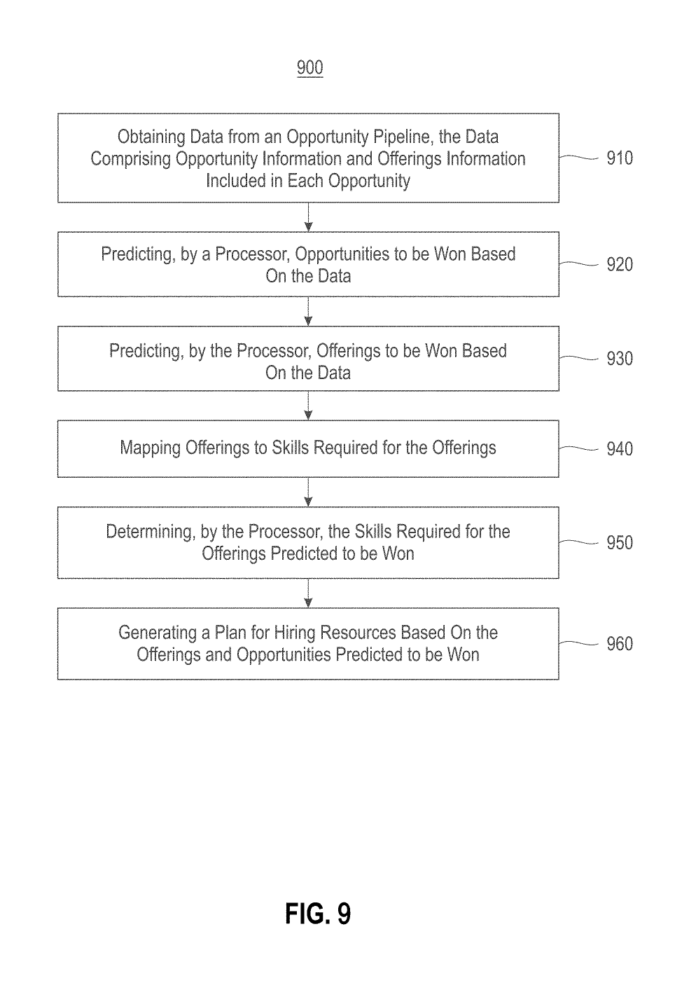

FIG. 9 illustrates a block diagram for a process 900 for matching skills for offerings, according to one embodiment. In block 910, process 900 obtains data including historical opportunity information and offering information. In one embodiment, the offering information includes an involved skill set or involved staff from which the skill set is inferred. In block 920, process 900 determines, by a processor (e.g., a processor in cloud computing environment 50, FIG. 1, system 300, FIG. 3, system 400, FIG. 4, system 500, FIG. 5, or system 600, FIG. 6), an associated skill set for each offering based on the data. In block 930, process 900 determines an amount of each skill associated with each unit of each offering. In block 940, process 900 forecasts (or predicts) skills for each offering under consideration based on the amount of each skill associated with each unit of each offering and the offering information.

In one embodiment, for process 900, determining an associated skill set associated with each offering may include: receiving a set of historical opportunities that comprises a set of offerings delivered, an involved skill set, a predetermined threshold for minimum support and a predetermined threshold for confidence; reading projects from a memory store; building a rule of size k of the involved skill set, where k is a positive integer; and determining support for the rule comprising a number of times the offering appeared along with the involved skill set across all opportunities. In one embodiment, determining an associated skill set associated with each offering may further include determining confidence that comprises a frequency determined by a total number of times in which that skill set uniquely appeared for corresponding offerings divided by a total number of times that the skill set appeared across all offerings in a historical data set.

In one embodiment, in process 900 determining an associated skill set associated with each offering may further include maintaining rules with support and confidence above the threshold for minimum support and the threshold for confidence, increasing a value of k and repeating receiving the set of historical opportunities that comprises a set of offerings delivered, the involved skill set, the predetermined threshold for minimum support and a predetermined threshold for confidence and reading projects from the memory store until there is no consequent size N meeting thresholds (where N is a positive integer), and determining a minimum set of skill sets with maximum skill set size in their consequent, covering all individual skill sets that meet the threshold for minimum support and the threshold for confidence requirements over the projects.

In one embodiment, for process 900 determining the amount of each skill associated with each unit of each offering may include determining skill units for each opportunity by summing up a number of individuals that worked on a corresponding opportunity and had that skill, and determining a contribution of each skill to offerings in each opportunity that require the corresponding skill. In one embodiment, for process 900 determining the amount of each skill associated with each unit of each offering may further include for each offering and corresponding required skill, determining amount of that skill for each unit of offering by computing a function of contribution of the corresponding required skill to a corresponding offering across all opportunities including the corresponding offering and the corresponding required skill.

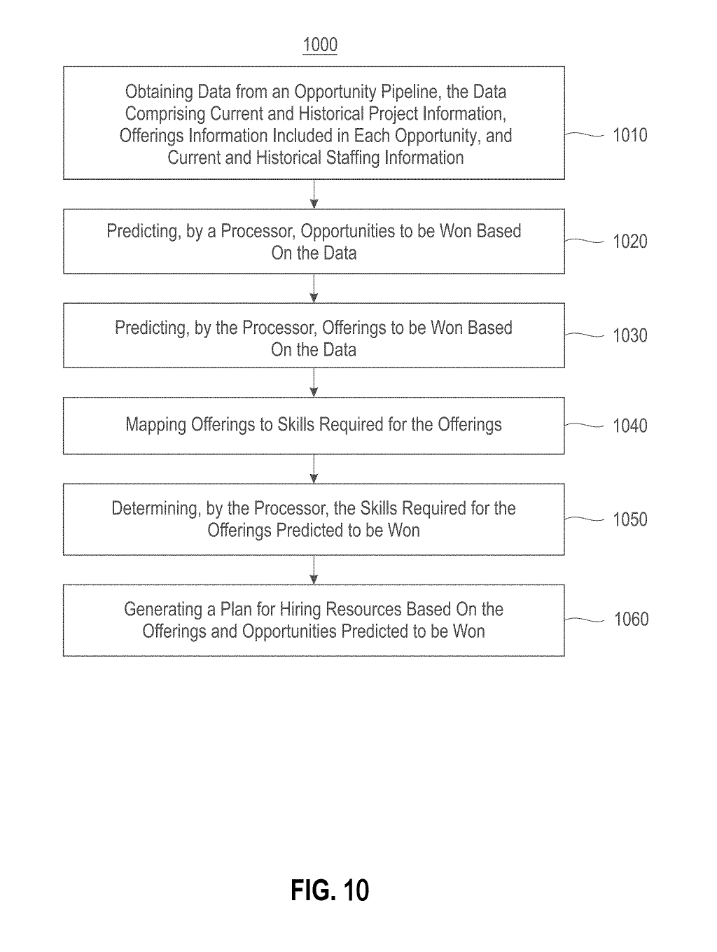

FIG. 10 illustrates a block diagram for a process 1000 for solution-aware staffing hiring based on project information, according to one embodiment. In block 1010, process 1000 obtains constraint information. In block 1020, process 1000 obtains data including current and historical project information, offerings information included in each opportunity, and current and historical staffing information. In block 1030, process 1000 predicts, by a processor (e.g., a processor in cloud computing environment 50, FIG. 1, system 300, FIG. 3, system 400, FIG. 4, system 500, FIG. 5, or system 600, FIG. 6), opportunities to be won based on the data. In block 1040, process 1000 maps offerings to skills required for the offerings predicted to be won. In block 1050, process 1000 determines, by the processor, the skills required for the offerings predicted to be won. In block 1060, process 1000 determines, by the processor, staffing hiring based on the opportunities predicted to be won, the constraint information and the determined skills required.

In one embodiment, for process 1000, the data further includes: resource locations, workload capacity information, budget information, penalty information, hiring timeline information, late delivery information, hiring cost information, and assignment cost of staff to opportunity information.

In one embodiment, for process 1000 the constraint information includes: total number of available resources at any point of time, resources available due to hiring, unmet demand being greater or equal to needed resources at that point of time, budget constraints at any time period that must not be exceeded, and capacities of maximum allocated resources to opportunities and any other capacities, hiring timelines that have to be fulfilled, and constraints insuring possible resource assignments.

In one embodiment, for process 1000 determining staffing hiring may include building an optimization model comprising a mixed integer linear programming model. In one embodiment, the optimization model may include processing for minimizing related costs of: staffing hiring at each time period, assignment of staff members to different opportunities in each location, and late delivery due to lack at least one of staff and skill, at particular times.

In one embodiment, for process 1000 determining staffing hiring may include determining how much staff needed to hire having particular skill sets, time frame for hiring the staff, assigning staff to different opportunities at different geographical locations, and providing times when the staff performs work on the different opportunities. In one embodiment, determining staffing hiring may include determining staffing hiring among all potential hires with given skill sets.

In one embodiment, in process 1000 the offerings to be won are predicted based on applying opportunity-offerings mapping input to opportunities expected to be won. In one embodiment, mapping the offerings to the skills required for the offerings includes determining a skill set associated with each offering and determining an amount of each skill associated with each unit of each offering.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for predicting and planning of staffing needs for services comprising:
obtaining data from an opportunity pipeline, the data comprising current and historical project information, offerings information included in each opportunity and current and historical staffing information;
generating an optimization model to provide a threshold for deals predicted to be won;
optimizing a threshold of win score for deals to be considered as predicted to be won; and
predicting opportunities to be won comprising:
executing a win prediction model for current opportunities in the opportunity pipeline;
filtering deals with scores less than the win score threshold;
processing a deal progress monitoring model for each remaining deal to predict a future event and related timeline; and
simulating progress of each deal by updating each deal with a predicted event until an end of a simulation time window.

2. The method of claim 1, wherein the opportunity pipeline further comprises: resource locations, workload capacity information, budget information, penalty information, hiring timeline information, late delivery information, hiring cost information, and assignment cost of staff to opportunity information.

3. The method of claim 1, wherein deals that end up with a predicted event as won are deals predicted to be won.

4. The method of claim 3, wherein the optimization model optimizes tradeoff between penalties paid to customers for late deliveries and any unnecessary hiring and staffing costs.

5. The method of claim 4, further comprising:
receiving a selected number of data buckets to be used; and
constructing, for any data bucket, pseudo-won deals from a number of deals equal to a particular number of that data bucket and that did not make it through any lower numbered data buckets.

6. The method of claim 5, wherein the pseudo-won deals are constructed as having a probability of winning equal to a probability that at least one of the deals used in constructing it will be won based on a score output from the win prediction model.

7. The method of claim 6, wherein the probability that at least one of the deals in a list for each bucket is determined based on assuming independence between chances of winning each deal.

8. A method for matching skills for offerings comprising:
obtaining data comprising historical opportunity information and offering information;
determining, by a processor, an associated skill set for each offering based on the data;
determining an amount of each skill associated with each unit of each offering; and
forecasting skills for each offering under consideration based on the amount of each skill associated with each unit of each offering and the offering information.

9. The method of claim 8, wherein the offering information comprises one of an involved skill set and involved staff from which the skill set is inferred.

10. The method of claim 9, wherein determining an associated skill set associated with each offering comprises:
receiving a set of historical opportunities that comprises a set of offerings delivered, the involved skill set, a predetermined threshold for minimum support and a predetermined threshold for confidence;
reading projects from a memory store;
building a rule of size k of the involved skill set, where k is a positive integer; and
determining support for the rule comprising a number of times the offering appeared along with the involved skill set across all opportunities.

11. The method of claim 10, wherein determining an associated skill set associated with each offering further comprises:
determining confidence that comprises a frequency determined by a total number of times in which that skill set uniquely appeared for corresponding offerings divided by a total number of times that the skill set appeared across all offerings in a historical data set.

12. The method of claim 11, wherein determining an associated skill set associated with each offering further comprises:
maintaining rules with support and confidence above the threshold for minimum support and the threshold for confidence;
increasing a value of k and repeating receiving the set of historical opportunities that comprises a set of offerings delivered, the involved skill set, the predetermined threshold for minimum support and a predetermined threshold for confidence and reading projects from the memory store until there is no consequent size N meeting thresholds, where N is a positive integer; and
determining a minimum set of skill sets with maximum skill set size in their consequent, covering all individual skill sets that meet the threshold for minimum support and the threshold for confidence requirements over the projects.

13. The method of claim 8, wherein determining the amount of each skill associated with each unit of each offering comprises:
determining skill units for each opportunity by summing up a number of individuals that worked on a corresponding opportunity and had that skill; and
determining a contribution of each skill to offerings in each opportunity that require the corresponding skill.

14. The method of claim 13, wherein determining the amount of each skill associated with each unit of each offering further comprises:
for each offering and corresponding required skill, determining amount of that skill for each unit of offering by computing a function of contribution of the corresponding required skill to a corresponding offering across all opportunities including the corresponding offering and the corresponding required skill.

15. A method for solution-aware staffing hiring based on project information comprising:
obtaining constraint information;
obtaining data comprising current and historical project information, offerings information included in each project, and current and historical staffing information;
predicting, by a processor, opportunities and offerings to be won based on the data;
mapping offerings to skills required for the offerings;
determining, by the processor, the skills required for the offerings predicted to be won; and
determining, by the processor, staffing hiring based on the opportunities predicted to be won, the constraint information and the determined skills required.

16. The method of claim 15, wherein the data further comprises: resource locations, workload capacity information, budget information, penalty information, hiring timeline information, late delivery information, hiring cost information, and assignment cost of staff to opportunity information.

17. The method of claim 16, wherein the constraint information comprises:
total number of available resources at any point of time, resources available due to hiring, unmet demand being greater or equal to needed resources at that point of time, budget constraints at any time period that must not be exceeded, and capacities of maximum allocated resources to opportunities and any other capacities, hiring timelines that have to be fulfilled, and constraints insuring possible resource assignments.

18. The method of claim 15, wherein determining staffing hiring comprises building an optimization model comprising a mixed integer linear programming model.

19. The method of claim 18, wherein the optimization model comprises processing for minimizing related costs of:
staffing hiring at each time period;
assignment of staff members to different opportunities in each location; and
late delivery due to lack at least one of staff and skill, at particular times.

20. The method of claim 15, wherein determining staffing hiring comprises determining how much staff needed to hire having particular skill sets, time frame for hiring the staff, assigning staff to different opportunities at different geographical locations, and providing times when the staff performs work on the different opportunities.

21. The method of claim 15, wherein the offerings to be won are predicted based on applying opportunity-offerings mapping input to opportunities expected to be won.

22. The method of claim 15, wherein mapping the offerings to the skills required for the offerings comprises determining a skill set associated with each offering and determining an amount of each skill associated with each unit of each offering.

23. The method of claim 15, wherein determining staffing hiring comprises determining staffing hiring among all potential hires with given skill sets.
